(19) United States
(12) Patent Application Publication
(10) Pub. No.: US 2025/0262867 A1
(43) Pub. Date: Aug. 21, 2025

(54) RECORDING DEVICE AND TEST PATTERN FORMING METHOD

(71) Applicant: SEIKO EPSON CORPORATION, Tokyo (JP)

(72) Inventor: Yoshiaki YAMAMOTO, SHIOJIRI-SHI (JP)

(21) Appl. No.: 19/058,947

(22) Filed: Feb. 20, 2025

(30) Foreign Application Priority Data
Feb. 21, 2024 (JP) 2024-024357

(51) Int. Cl. B41J 2/21; B41J 25/00

(52) U.S. Cl. CPC B41J 2/2135; B41J 2/2103; B41J 25/005

(57) ABSTRACT

A test pattern includes a plurality of individual patterns along a main scanning direction by liquid ejection from each of a plurality of first nozzles. The individual patterns adjacent to each other in a sub scanning direction are located at positions shifted from each other in the main scanning direction. The plurality of first nozzles include a first sequential nozzle group that is sequential in the sub scanning direction and a second sequential nozzle group that is sequential in the sub scanning direction. The test pattern includes a first pattern group derived from liquid ejection from the first sequential nozzle group and a second pattern group derived from liquid ejection from the second sequential nozzle group. The control unit performs control to form the test pattern in which at least the first pattern group and the second pattern group are arranged in the main scanning direction by performing sub scanning between formation of the first pattern group and formation of the second pattern group.

The present application is based on, and claims priority from JP Application Serial Number 2024-024357, filed Feb. 21, 2024, the disclosure of which is hereby incorporated by reference herein in its entirety.

### BACKGROUND

### 1. Technical Field

The present disclosure relates to a recording device capable of forming a test pattern indicating an ejection state of a nozzle, and a test pattern forming method.

### 2. Related Art

As a recording device, an inkjet printer that ejects ink as liquid from a recording head onto a recording medium has been known. When viscosity of the ink in a nozzle increases, air bubbles are mixed into the nozzle, dust or paper powder adheres to the nozzle, or the like, an ink droplet is not ejected from the nozzle, or an ink droplet ejected from the nozzle does not land at a normal position on the medium in some cases. Here, a nozzle from which an ink droplet is not normally ejected is referred to as a defective nozzle.

JP 2022-11429 A discloses printing a test pattern on a printing medium, the test pattern indicating an ejection state of each nozzle by ruled lines along a main scanning direction, that is, an individual pattern, in order to inspect an ejection state of ink from a nozzle row. A length of the test pattern in a sub scanning direction corresponds to a length of the nozzle row in the sub scanning direction. For example, when the nozzle row of a recording head includes four rows of C (cyan), M (magenta), Y (yellow), and K (black), a test pattern is printed in which a pattern group of C, a pattern group of M, a pattern group of Y, and a pattern group of K are arranged in a main scanning direction.

The recording head includes a “vertical array head” having a color nozzle array in which a nozzle group for C, a nozzle group for M, and a nozzle group for Y are arranged in one row along a nozzle row for K. In the color nozzle row, there is a nozzle that is not used between the nozzle group for C and the nozzle group for M, and there is a nozzle that is not used between the nozzle group for M and the nozzle group for Y. Since the vertical array head includes only two nozzle rows, a test pattern is to be printed in which two pattern groups of K and the colors are arranged in the main scanning direction. In this case, when a defective nozzle of the nozzle row for K and a defective nozzle of the color nozzle row are at the same position, there is a possibility that the positions corresponding to the defective nozzles cannot be detected from the test pattern. In addition, since a gap is formed at a color change in pattern groups derived from ink ejection from the color nozzle row, there is a possibility that a position corresponding to a defective nozzle cannot be detected from the test pattern also when a nozzle corresponding to an individual pattern at a location adjacent to the gap is the defective nozzle. When the position corresponding to the defective nozzle is not detected, the defective nozzle included in the nozzle row is not detected.

Note that the above-described problem is also conceivable in a recording device other than an inkjet printer having a vertical array head, such as a monochrome printer having only the nozzle row for K in a recording head.

### SUMMARY

A recording device of the present disclosure includes an aspect including a recording head including a first nozzle row in which a plurality of first nozzles capable of ejecting liquid onto a medium are arranged, and a control unit configured to control main scanning for moving the recording head along a main scanning direction intersecting with an arrangement direction of the plurality of first nozzles, sub scanning for moving at least one of the medium and the recording head along a sub scanning direction intersecting with the main scanning direction, and ejection of the liquid from the recording head, wherein the control unit is capable of controlling formation of a test pattern including a plurality of individual patterns along the main scanning direction by liquid ejection from each of the plurality of first nozzles, the individual patterns adjacent to each other in the sub scanning direction are located at positions shifted from each other in the main scanning direction, the plurality of first nozzles include a first sequential nozzle group that is sequential in the sub scanning direction and a second sequential nozzle group that is sequential in the sub scanning direction, the test pattern includes a first pattern group derived from liquid ejection from the first sequential nozzle group and a second pattern group derived from liquid ejection from the second sequential nozzle group, and the control unit performs control to form the test pattern in which at least the first pattern group and the second pattern group are arranged in the main scanning direction by performing the sub scanning between formation of the first pattern group and formation of the second pattern group.

Additionally, a test pattern forming method of the present disclosure includes an aspect being a test pattern forming method for forming a test pattern by performing main scanning for moving a recording head including a first nozzle row in which a plurality of first nozzles capable of ejecting liquid onto a medium are arranged along a main scanning direction intersecting with an arrangement direction of the plurality of first nozzles, and sub scanning for moving at least one of the medium and the recording head along a sub scanning direction intersecting with the main scanning direction, wherein the test pattern includes a plurality of individual patterns along the main scanning direction by liquid ejection from each of the plurality of first nozzles, the individual patterns adjacent to each other in the sub scanning direction are located at positions shifted from each other in the main scanning direction, the plurality of first nozzles include a first sequential nozzle group that is sequential in the sub scanning direction and a second sequential nozzle group that is sequential in the sub scanning direction, the test pattern forming method includes a first pattern group forming step for forming a first pattern group on the medium by ejecting the liquid from the first sequential nozzle group, a second pattern group forming step for forming a second pattern group on the medium by ejecting the liquid from the second sequential nozzle group, and a sub scanning step for performing the sub scanning such that the first pattern group and the second pattern group are arranged in the main scanning direction.

### BRIEF DESCRIPTION OF THE DRAWINGS

FIG. 1 is a diagram schematically illustrating an example of a recording device.

FIG. 2 is a diagram schematically illustrating an example of a recording head and a test pattern.

FIG. 3 is a diagram schematically illustrating a classification example of nozzle groups.

FIG. 4 is a diagram schematically illustrating an example of the test pattern.

FIG. 5 is a diagram schematically illustrating an example of a test pattern forming method.

FIG. 6 is a diagram schematically illustrating the example of the test pattern forming method.

FIG. 7 is a diagram schematically illustrating an example of the test pattern including an individual pattern position of a defective nozzle.

FIG. 8 is a diagram schematically illustrating another example of the test pattern.

FIG. 9 is a diagram schematically illustrating an example of a test pattern including an individual pattern position of a defective nozzle in a comparative example.

### DESCRIPTION OF EMBODIMENTS

Hereinafter, an embodiment of the present disclosure will be described. Of course, the following embodiment is merely illustrative of the present disclosure, and not all of the characteristics presented in the embodiment are essential to the solution of the disclosure.

### (1) Overview of Aspect Included in Present Disclosure

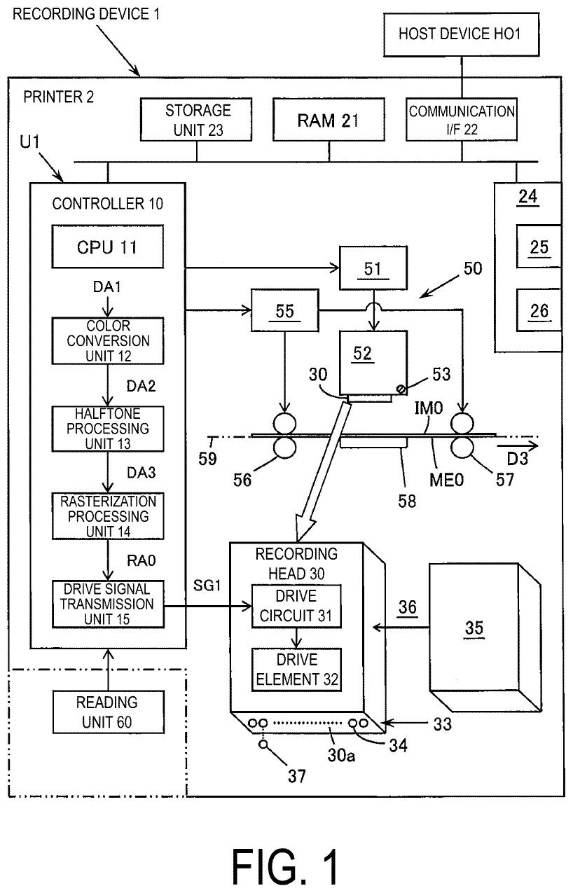

First, an overview of aspects included in the present disclosure will be described with reference to examples illustrated in FIGS. 1 to 9. Note that the drawings in the present application are diagrams schematically illustrating the examples, a scale of each part may differ from an actual scale in order to make each part of these drawings larger enough to be easily recognizable, magnifications in respective directions indicated in these drawings may be different from each other, and the drawings may be inconsistent with one another. Of course, each element of the present aspect is not limited to a specific example indicated by a reference sign. In “Overview of Aspect Included in Present Disclosure”, a parenthesized word indicates a supplementary description of an immediately preceding word.

### Aspect 1

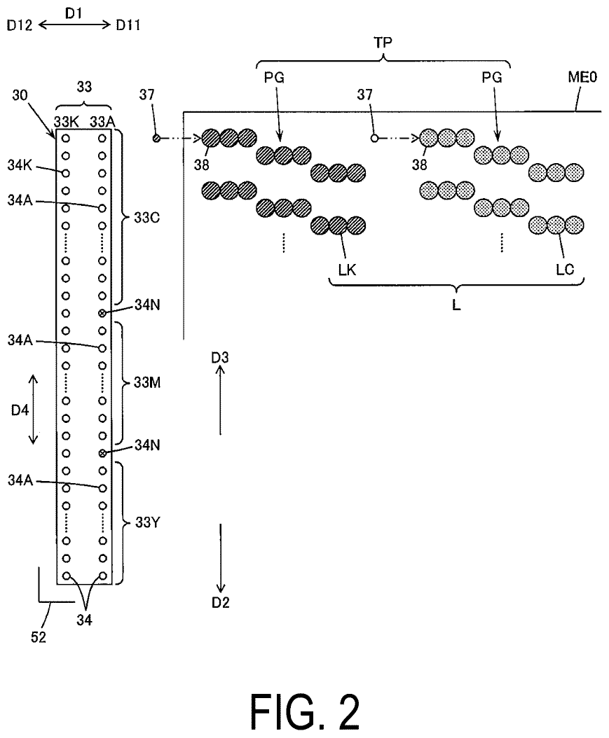

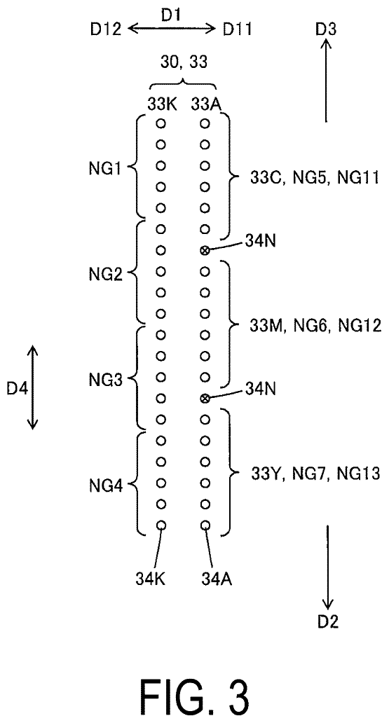

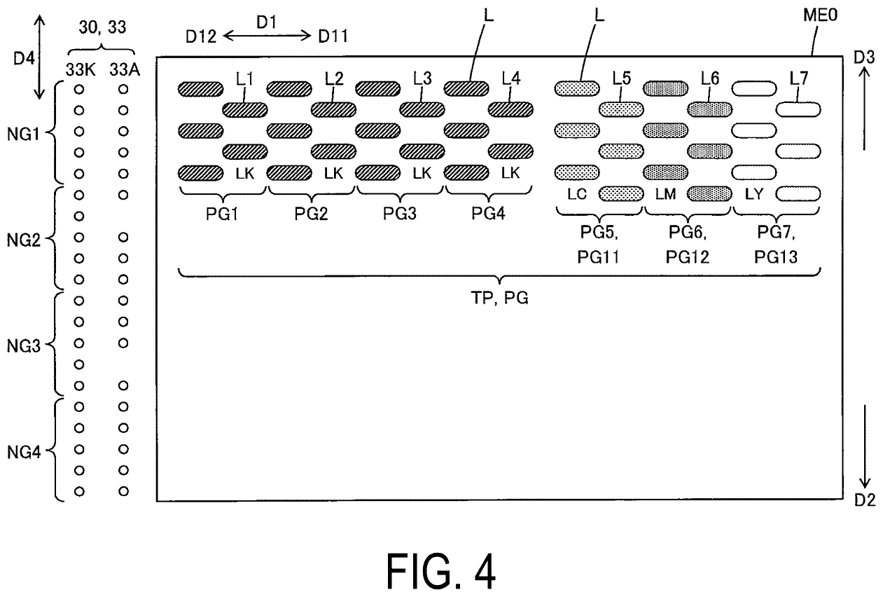

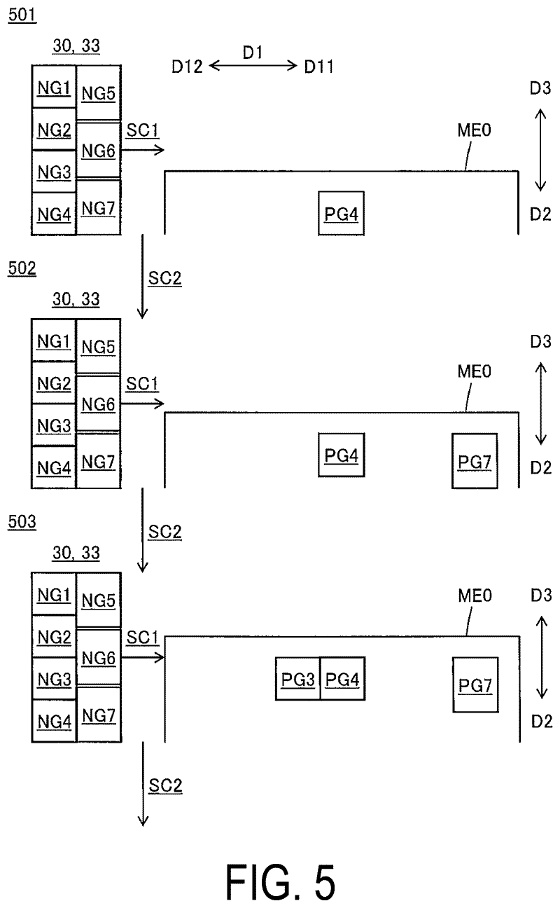

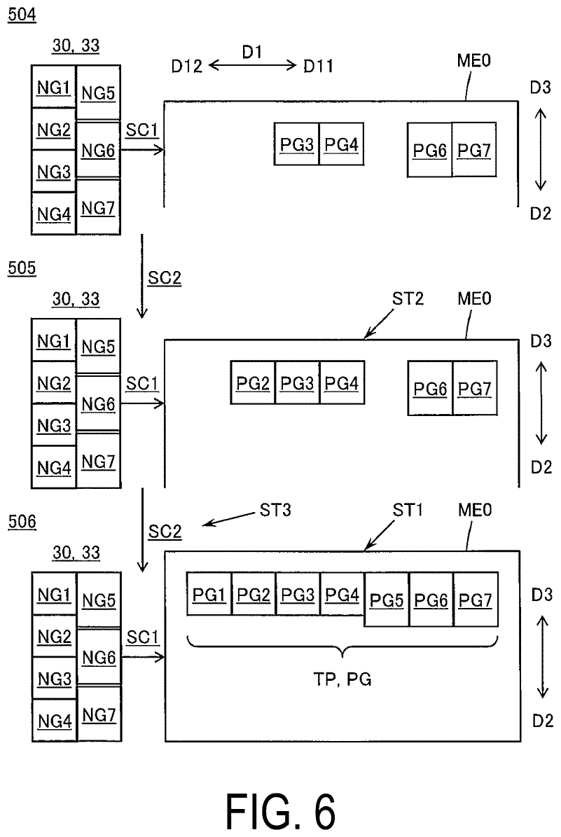

As illustrated in FIG. 1, a recording device 1 according to an aspect includes a recording head 30 and a control unit U1. The recording head 30 includes a first nozzle row (for example, a nozzle row 33K for K) in which a plurality of first nozzles (for example, a nozzle 34K for K) that can eject liquid 36 onto a medium MEO are arranged, as illustrated in FIGS. 2 to 4, and the like. The control unit U1 controls, as illustrated in FIGS. 5 and 6, main scanning SC1 for moving the recording head 30 along a main scanning direction D1 intersecting with an arrangement direction D4 of the plurality of first nozzles (34K), sub scanning SC2 for moving at least one of the medium ME0 and the recording head 30 along a sub scanning direction D2 intersecting with the main scanning direction D1, and ejection of the liquid 36 from the recording head 30. As illustrated in FIGS. 2, 4, and the like, the control unit U1 can control formation of a test pattern TP including a plurality of individual patterns L along the main scanning direction D1 by liquid ejection from each of the plurality of first nozzles (34K). Here, the individual patterns L adjacent to each other in the sub scanning direction D2 are located at positions shifted from each other in the main scanning direction D1. As illustrated in FIGS. 3, 4, and the like, the plurality of first nozzles (34K) include a first sequential nozzle group NG1 that is sequential in the sub scanning direction D2 and a second sequential nozzle group NG2 that is sequential in the sub scanning direction D2. The test pattern TP includes a first pattern group PG1 derived from liquid ejection from the first sequential nozzle group NG1 and a second pattern group PG2 derived from liquid ejection from the second sequential nozzle group NG2. As illustrated in FIGS. 5 and 6, the control unit U1 performs control to form the test pattern TP in which at least the first pattern group PG1 and the second pattern group PG2 are arranged in the main scanning direction D1 by performing the sub scanning SC2 between formation of the first pattern group PG1 and formation of the second pattern group PG2.

Since the first pattern group PG1 formed by the first sequential nozzle group NG1 in the first nozzle row (33K) and the second pattern group PG2 formed by the second sequential nozzle group NG2 in the first nozzle row (33K) are arranged in the main scanning direction D1, the number of individual patterns L formed at the same position in the sub scanning direction D2 is increased. Accordingly, even when some of the individual patterns L among the plurality of individual patterns L formed at the same position in the sub scanning direction D2 are not formed due to ejection failures of the nozzles, positions corresponding to defective nozzles LN are detected since the remaining individual patterns L are formed. Therefore, according to the aspect described above, it is possible to provide a recording device in which a situation in which a defective nozzle having an ejection failure cannot be detected can be suppressed.

Here, examples of the medium include various objects such as paper, cloth, and film.

The control unit may perform control such that the second pattern group is formed after the first pattern group is formed, or may perform control such that the first pattern group is formed after the second pattern group is formed.

The “first”, “second”, or the like in the present application are terms for identifying each constituent element included in a plurality of constituent elements having similarity, and do not mean an order. Which of the plurality of components applies to “first”, “second”, or the like is determined relatively.

Note that the above-described additional remarks are also applied to the following aspects.

### Aspect 2

As illustrated in FIGS. 3 and 4, the plurality of first nozzles (34K) may further include a third sequential nozzle group NG3 that is sequential in the sub scanning direction D2 and a fourth sequential nozzle group NG4 that is sequential in the sub scanning direction D2. The test pattern TP may include the first pattern group PG1, the second pattern group PG2, a third pattern group PG3 derived from liquid ejection from the plurality of third sequential nozzles, and a fourth pattern group PG4 derived from liquid ejection from the plurality of fourth sequential nozzles. In the test pattern TP, the number of pattern groups PG derived from liquid ejection from the first nozzle row (33K) may be four. As illustrated in FIGS. 5 and 6, the control unit U1 may perform control to form the test pattern TP in which at least the first pattern group PG1, the second pattern group PG2, the third pattern group PG3, and the fourth pattern group PG4 are arranged in the main scanning direction D1, by performing the sub scanning SC2 between formation of the second pattern group PG2 and formation of the third pattern group PG3, and performing the sub scanning SC2 between formation of the third pattern group PG3 and formation of the fourth pattern group PG4.

As a result of examination, it has been found that the number of pattern groups PG derived from liquid ejection from one nozzle row is optimal to be four in terms of formation speed of the test pattern TP and detection accuracy of the defective nozzle LN. Therefore, according to the aspect described above, it is possible to provide a recording device that is suitable in terms of forming speed of a test pattern and detection accuracy of a defective nozzle.

### Aspect 3

As illustrated in FIGS. 2 to 4, and the like, the recording head 30 may include a second nozzle row (for example, a color nozzle row 33A) along the first nozzle row (33K), the second nozzle row (33A) having a plurality of second nozzles (for example, color nozzles 34A) being arranged therein. The plurality of second nozzles (34A) may include a first sequential color nozzle group NG11 in which a plurality of first color nozzles capable of ejecting liquid 36 of a first color (for example, C) onto the medium ME0 are sequentially arranged, a second sequential color nozzle group NG12 in which a plurality of second color nozzles capable of ejecting the liquid 36 of a second color (for example, M) onto the medium ME0 are sequentially arranged, and a third sequential color nozzle group NG13 in which a plurality of third color nozzles capable of ejecting the liquid 36 of a third color (for example, Y) onto the medium ME0 are sequentially arranged. The test pattern TP may include a first color pattern group PG11 derived from liquid ejection from the first sequential color nozzle group NG11, a second color pattern group PG12 derived from liquid ejection from the second sequential color nozzle group NG12, and a third color pattern group PG13 derived from liquid ejection from the third sequential color nozzle group NG13. The control unit U1 may perform control to form the test pattern TP in which at least the first pattern group PG1, the second pattern group PG2, and the first color pattern group PG11 are arranged in the main scanning direction D1.

In the above case, since the individual pattern L derived from liquid ejection from the second nozzle (34K) is formed at the same position as the individual pattern L derived from liquid ejection from the first nozzle (34A) in the sub scanning direction D2, it is possible to further suppress the situation in which a defective nozzle cannot be detected.

### Aspect 4

As illustrated in FIG. 3 and the like, the plurality of second nozzles (34A) may include a fifth sequential nozzle group NG5 that is sequential in the sub scanning direction D2 and a sixth sequential nozzle group NG6 that is sequential in the sub scanning direction D2. As illustrated in FIG. 4 and the like, the test pattern TP may include a fifth pattern group PG5 derived from liquid ejection from the fifth sequential nozzle group NG5 and a sixth pattern group PG6 derived from liquid ejection from the sixth sequential nozzle group NG6. As illustrated in FIGS. 5 and 6, the control unit U1 may perform control to form the test pattern TP in which at least the first pattern group PG1, the second pattern group PG2, the fifth pattern group PG5, and the sixth pattern group PG6 are arranged in the main scanning direction D1 by performing the sub scanning SC2 between formation of the fifth pattern group PG5 and formation of the sixth pattern group PG6.

In the above case, since the two pattern groups PG derived from liquid ejection from the first nozzle row (33K) and the two pattern groups PG derived from liquid ejection from the second nozzle row (33A) are formed at the same position in the sub scanning direction D2, it is possible to further suppress the situation in which a defective nozzle cannot be detected. Note that when the sub scanning SC2 is repeated in order to arrange the pattern groups PG in the main scanning direction D1, a time required to form the test pattern TP becomes longer. When the number of nozzle rows of the recording head 30 is two or less, an effect of improving detection accuracy of the defective nozzle LN is particularly large as compared to a formation speed of the test pattern TP. Therefore, the aspect described above is suitable for a case where the number of nozzle rows of the recording head is two or less.

### Aspect 5

As illustrated in FIGS. 2, 4, and the like, the test pattern TP may include a plurality of the pattern groups PG including the first pattern group PG1 and the second pattern group PG2. The control unit U1 may perform control to form the test pattern TP in which the plurality of pattern groups PG are arranged in the main scanning direction D1 so that a position in the sub scanning direction D2 of each of the individual patterns L included in each of the pattern groups PG coincides with a position in the sub scanning direction D2 of any of the individual patterns L included in the other pattern groups PG.

In the above case, at a position in the sub scanning direction D2 of each individual pattern L, any of the other individual patterns L is present, thus it is possible to further suppress the situation in which a defective nozzle cannot be detected.

### Aspect 6

Incidentally, a test pattern forming method according to an aspect is a test pattern forming method for forming the test pattern TP by performing the main scanning SC1 for moving the recording head 30 including the first nozzle row (33K) in which the plurality of first nozzles (34K) capable of ejecting the liquid 36 onto the medium ME0 are arranged along the main scanning direction D1 intersecting with the arrangement direction D4 of the plurality of first nozzles (34K), and the sub scanning SC2 for moving at least one of the medium ME0 and the recording head 30 along the sub scanning direction D2 intersecting with the main scanning direction D1. The present test pattern forming method includes the following steps, as illustrated in FIGS. 5 and 6.

(a1) A first pattern group forming step ST1 for forming the first pattern group PG1 on the medium ME0 by ejecting the liquid 36 from the first sequential nozzle group NG1.

(a2) A second pattern group forming step ST2 for forming the second pattern group PG2 on the medium ME0 by ejecting the liquid 36 from the second sequential nozzle group NG2.

(a3) A sub scanning step ST3 for performing the sub scanning SC2 such that the first pattern group PG1 and the second pattern group PG2 are arranged in the main scanning direction D1.

According to the aspect described above, it is possible to provide a test pattern forming method capable of suppressing a situation in which a defective nozzle having an ejection failure cannot be detected.

Here, the second pattern group forming step may be performed after the first pattern group forming step, or the first pattern group forming step may be performed after the second pattern group forming step.

Further, the above-described aspect can be applied to a recording system including the above-described recording device, a control method for the above-described recording device, a control method for the above-described recording system, a control program for the above-described recording device, a control program for the above-described recording system, and a computer-readable recording medium in which any of the above-described control programs is recorded. The above-described recording device may include a plurality of separate units.

### (2) Specific Example of Recording Device

FIG. 1 schematically illustrates the recording device 1. Although the recording device 1 in this specific example is a printer 2 itself, the recording device 1 may be a combination of the printer 2 and a host device HO1. The printer 2 may include a reading unit 60 that reads a printed image IMO, and may include additional elements not illustrated in FIG. 1. FIG. 2 schematically illustrates the nozzle row 33 of the recording head 30 and the test pattern TP on the medium ME0. The recording head 30 illustrated in FIG. 2 is a “vertical array head” including the color nozzle row 33A in which a nozzle group 33C for C (cyan), a nozzle group 33M for M (magenta), and a nozzle group 33Y for Y (yellow) are arranged in one row along the nozzle row 33K for K (black). FIG. 3 schematically illustrates a classification of the nozzle groups in this specific example. FIG. 4 schematically illustrates the test pattern TP on the medium ME0.

The printer 2 illustrated in FIG. 1 is a serial printer that is a type of ink jet printer that ejects the liquid 36 as a droplet 37. The printer 2 includes a controller 10, a RAM (Random Access Memory) 21, which is a semiconductor memory, a communication I/F (Interface) 22, a storage unit 23, an operation panel 24, the recording head 30, a drive unit 50, the reading unit 60, and the like. The controller 10 and the drive unit 50 are an example of the control unit U1. The controller 10, the RAM 21, the communication I/F 22, the storage unit 23, and the operation panel 24 are coupled to a bus and are configured to be capable of inputting and outputting information to and from one another.

The controller 10 includes a CPU (Central Processing Unit) 11 which is a processor, a color conversion unit 12, a halftone processing unit 13, a rasterization processing unit 14, a drive signal transmission unit 15, and the like. The controller 10 controls the main scanning and the sub scanning by the drive unit 50 and ejection of the droplet 37 by the recording head 30 based on original image data DA1 acquired from any one of the host device HO1, a memory card (not illustrated), and the like. It can be said that the controller 10 controls the drive unit 50 and the recording head 30 so that the printed image IMO is formed on the medium ME0. RGB data having integer values of 28 gradations or 216 gradations of R (red), G (green), and B (blue) for each pixel, for example, can be applied to the original image data DA1. The controller 10 can be configured of an SoC (System on a Chip) or the like.

The CPU 11 is an apparatus that mainly performs information processing and control in the printer 2.

With reference to, for example, a color conversion LUT (look up table) that defines a correspondence relationship between R, G, and B gradation values and C, M, Y, and K gradation values, the color conversion unit 12 converts RGB data into ink amount data DA2 having integer values of 28 gradations or 216 gradations of C, M, Y, and K for each pixel. The ink amount data DA2 represents use amounts of the liquid 36 of C, M, Y, and K in units of pixels. Further, when a resolution of the RGB data is different from a printing resolution, the color conversion unit 12 first converts the resolution of the RGB data to the printing resolution, or converts a resolution of the ink amount data DA2 to the printing resolution.

The halftone processing unit 13 generates dot data DA3 by reducing the number of gradations of the gradation value by performing halftone processing by any of a dither method, an error diffusion method, or the like on the gradation values of each pixel constituting the ink amount data DA2. The dot data DA3 represents a formation state of a dot 38 of the droplet 37 in units of pixels. The dot data DA3 may be binary data indicating whether a dot is formed or not, or may be multiple-value data of three or more gradations that can correspond to dots with different sizes, such as small, medium, and large dots.

The rasterization processing unit 14 generates raster data RA0 by performing rasterization processing in which the dot data DA3 is rearranged in an order in which the dots 38 are formed by the drive unit 50.

The drive signal transmission unit 15 generates a drive signal SG1 from the raster data RA0 and outputs the drive signal SG1 to a drive circuit 31 of the recording head 30. The drive signal SG1 corresponds to a voltage signal applied to a drive element 32 of the recording head 30. For example, when the dot data DA3 is “dot formation”, the drive signal transmission unit 15 outputs the drive signal SG1 for ejecting a droplet for dot formation. When the dot data DA3 is ternary or higher data, the drive signal transmission unit 15 outputs the drive signal SG1 for ejecting a droplet for a large dot when the dot data DA3 is “large dot formation”, and outputs the drive signal SG1 for ejecting a droplet for a small dot when the dot data DA3 is “small dot formation”.

The elements (11 to 15) described above may be configured of an ASIC (Application Specific Integrated Circuit), and data that is a processing target may be directly read from the RAM 21 or processed data may be directly written to the RAM 21.

The drive unit 50 controlled by the controller 10 includes a carriage drive unit 51 including a servomotor and a roller drive unit 55 including a servomotor. The drive unit 50 causes a carriage 52 to reciprocate along the main scanning direction D1 according to driving of the carriage drive unit 51 according to control by the controller 10, and feeds the medium ME0 in a feeding direction D3 along a transport path 59 according to driving of the roller drive unit 55. As illustrated in FIG. 2, the main scanning direction D1 is a direction intersecting with the arrangement direction D4 of the nozzles 34 in the nozzle row 33, and is a direction orthogonal to the arrangement direction D4, for example. FIG. 2 illustrates that a right direction is a forward direction D11 of the main scanning and a left direction is a backward direction D12 of the main scanning. The feeding direction D3 is a direction intersecting with the main scanning direction D1, and is, for example, a direction orthogonal to the main scanning direction D1. In FIG. 1, the feeding direction D3 is the right direction, a left side is called upstream, and a right side is called downstream. The sub scanning direction D2 illustrated in FIG. 2 is a direction opposite to the feeding direction D3. It can also be said that the carriage drive unit 51 performs the main scanning in which a relative positional relationship between the recording head 30 and the medium ME0 is changed along the main scanning direction D1. The roller drive unit 55 includes a transport roller pair 56 and a discharge roller pair 57. Under the control by the controller 10, the roller drive unit 55 performs the sub scanning for sending the medium ME0 in the feeding direction D3, by rotating a driving transport roller of the transport roller pair 56 and a driving discharge roller of the discharge roller pair 57. It can be said that the roller drive unit 55 performs the sub scanning in which a relative positional relationship between the recording head 30 and the medium ME0 is changed along the sub scanning direction D2 intersecting with the main scanning direction D1. Although the carriage 52 illustrated in FIG. 2 does not move in the sub scanning direction D2, the drive unit 50 may achieve the sub scanning by moving the carriage 52 in the sub scanning direction D2. At this time, the medium ME0 need not be moved in the sub scanning direction D2, and the drive unit 50 may achieve the sub scanning by moving both the carriage 52 and the medium ME0 in the sub scanning direction D2.

The medium ME0 is a printed matter that holds a printed image. A material of the medium ME0 is not particularly limited, and various materials such as paper, resin, and metal can be considered. A shape of the medium ME0 is also not particularly limited, and various shapes such as a rectangle and a roll shape can be considered, and a three-dimensional shape may be used.

A platen 58 is below the transport path 59 and supports the medium ME0 by coming into contact with the medium ME0 present on the transport path 59. The carriage 52 is mounted with the recording head 30. A liquid cartridge 35 that supplies the recording head 30 with the liquid 36 that is ejected as the droplet 37 may be mounted at the carriage 52. Of course, the liquid 36 may be supplied from the liquid cartridge 35 installed outside the carriage 52 to the recording head 30 via a tube. The carriage 52 is fixed to an endless belt (not illustrated) and is movable in the main scanning direction D1 along an elongated guide 53 in which a longitudinal direction is in the main scanning direction D1. The recording head 30 to be controlled by the controller 10 includes the drive circuit 31 and the drive element 32, and attaches the liquid 36 to the medium ME0 by ejecting the droplet 37 toward the medium ME0 supported by the platen 58. Therefore, it can be said that the control unit U1 controls ejection of the droplet 37 from the recording head 30.

The drive circuit 31 applies a voltage signal to the drive element 32 according to the drive signal SG1 input from the drive signal transmission unit 15. The drive element 32 may be a piezoelectric element that applies pressure to the liquid 36 inside a pressure chamber communicating with the nozzle 34, may be a drive element that ejects the droplet 37 from the nozzle 34 by generating a bubble inside the pressure chamber with heat, or the like. A pressure chamber of the recording head 30 is supplied with the liquid 36 from the liquid cartridge 35. The liquid 36 in the pressure chamber is ejected as the droplet 37 toward the medium ME0 from the nozzle 34 by the drive element 32. Due to this, the dot 38 of the droplet 37 is formed on the medium ME0, the printed image IMO expressed by a pattern of the dot 38 is formed on the medium ME0. While the recording head 30 moves in the main scanning direction D1, the dot 38 according to the raster data RA0 is formed, and the medium ME0 is repeatedly fed in the feeding direction D3 by one sub scanning so that the printed image IM0 is formed on the medium ME0. Note that the printer 2 may perform bi-directional recording in which the printed image IM0 is formed by both the main scanning in the forward direction D11 and the main scanning in the backward direction D12, or may perform uni-directional recording in which the printed image IM0 is formed by only one of the main scanning in the forward direction D11 and main scanning in the backward direction D12.

The RAM 21 stores the original image data DA1 and the like received from the host device HO1, a memory (not illustrated), or the like. The communication I/F 22 is connected to the host device HO1 by wire or wirelessly, and inputs and outputs information to and from the host device HO1. The host device HO1 includes a computer such as a personal computer or a tablet terminal, a mobile phone such as a smartphone, a digital camera, and a digital video camera. The storage unit 23 may be a nonvolatile semiconductor memory such as a flash memory, a magnetic storage apparatus such as a hard disk, or the like. The operation panel 24 includes an output unit 25 such as a liquid crystal panel that displays information, and an input unit 26 such as a touchscreen that receives an operation onto a display screen.

The reading unit 60 can read the test pattern TP and the like. The reading unit 60 may be an image sensor of a CIS (Contact Image Sensor) type or a CCD (Charge Coupled Devices) type, and a CMOS (Complementary Metal-Oxide Semiconductor) image sensor, and a solid imaging element such as a line sensor or an area sensor including CCD, or the like. An external scanner as the reading unit 60 may be coupled to the printer 2. The reading unit 60 in this specific example includes an analog/digital conversion circuit that converts an analog amount of a detection voltage of each pixel into a digital value, and an analog density amount corresponding to each detection voltage is converted into a digital density value at the analog/digital conversion circuit and is output to the controller 10.

The recording head 30 includes, at a nozzle surface 30a, the nozzle row 33 in which the plurality of nozzles 34 capable of ejecting the droplet 37 onto the medium ME0 are arranged at intervals of the predetermined nozzle pitch in the arrangement direction D4. Here, the nozzle means a small hole through which a droplet is jetted, and the nozzle row means an arrangement of a plurality of the nozzles. The nozzle surface 30a is an ejection surface of the droplet 37. Of course, the dot 38 of C is formed from the droplet 37 of C on the medium ME0, the dot 38 of M is formed from the droplet 37 of M on the medium ME0, the dot 38 of Y is formed from the droplet 37 of Y on the medium ME0, and the dot 38 of K is formed from the droplet 37 of K on the medium ME0.

The recording head 30 illustrated in FIG. 2 includes the nozzle row 33K for K in which the plurality of nozzles 34K for K capable of ejecting the liquid 36 of K onto the medium ME0 are arranged, and the color nozzle row 33A in which the plurality of color nozzles 34A capable of ejecting the liquid 36 of the colors other than K onto the medium ME0 are arranged. Here, the nozzle 34K for K is an example of a first nozzle, the nozzle row 33K for K is an example of the first nozzle row, the color nozzle 34A is an example of the second nozzle, and the color nozzle row 33A is an example of the second nozzle row. Since the color nozzle row 33A is parallel to the nozzle row 33K for K, it can be said that the color nozzle row 33A is along the nozzle row 33K for K. Of course, even when the nozzle rows are not strictly parallel, it can be said that the color nozzle row 33A is along the nozzle row 33K for K, as long as the nozzle row 33K for K and the color nozzle row 34A are each arranged so as to intersect with the main scanning direction. In each of the nozzle rows (33K and 33A) illustrated in FIG. 2, the plurality of nozzles 34 are arranged in one row at intervals of the predetermined nozzle pitch in the arrangement direction D4. The plurality of nozzles 34 of each of the nozzle rows (33K and 33A) may be arranged in a staggered pattern, that is, in two rows at intervals of the predetermined nozzle pitch in the arrangement direction D4. Here, the arrangement direction of the plurality of nozzles 34 arranged in a staggered manner is an arrangement direction of the nozzles focusing on each of the two rows.

The color nozzle row 33A is divided into a plurality of color nozzle groups in the arrangement direction D4. In the color nozzle row 33A illustrated in FIG. 2, the nozzle group 33C for C, the nozzle group 33M for M, and the nozzle group 33Y for Y are arranged in this order in the sub scanning direction D2. In the sub scanning direction D2, there are one or more unused nozzles 34N between the nozzle group 33C for C and the nozzle group 33M for M, and there are one or more unused nozzles 34N between the nozzle group 33M for M and the nozzle group 33Y for Y. The unused nozzle 34N means a nozzle that is included in the color nozzle row 33A but is not used. The reason why the unused nozzle 34N is provided in the color nozzle row 33A is to secure a certain degree of thicknesses of partition walls for dividing a flow path of the liquid 36 for the respective colors.

In the test pattern TP, an ejection state of each nozzle 34 is indicated by the linear individual pattern L along the main scanning direction D1. Macroscopically, it can be said that the individual pattern L is a line along the main scanning direction D1. The controller 10 can control formation of the test pattern TP including the plurality of individual patterns L along the main scanning direction D1 by liquid ejection from each of the plurality of nozzles 34. Since the plurality of individual patterns L are formed at intervals of a nozzle pitch in the sub scanning direction D2, the individual patterns L adjacent to each other in the sub scanning direction D2 are located at positions shifted from each other in the main scanning direction D1. FIG. 2 illustrates the pattern groups PG in which the plurality of the individual patterns L are divided into three in the main scanning direction D1 and arranged in a staircase pattern, for each color. Macroscopically, the pattern group PG can also be said to be a pitch line group. Note that the number into which the plurality of individual patterns L are divided in the main scanning direction D1 is not limited to three, and may be four or more, for example.

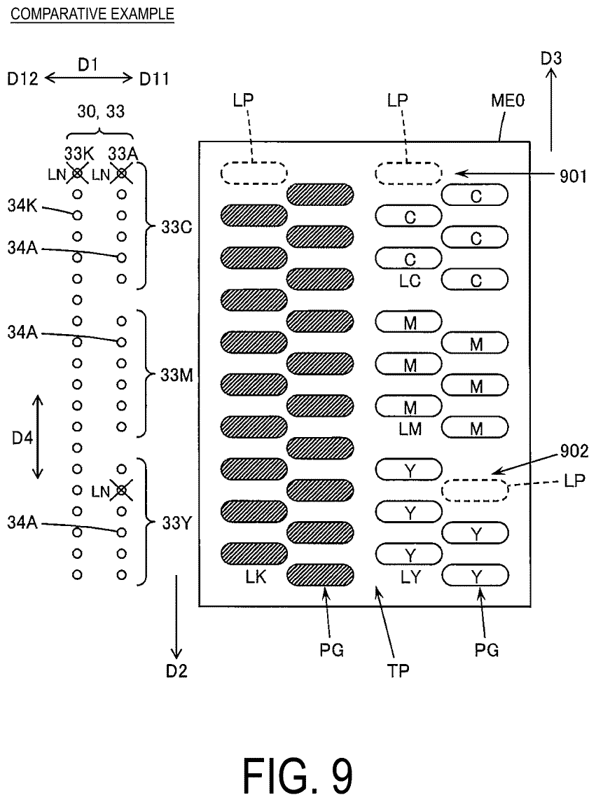

Here, as in a comparative example illustrated in FIG. 9, it is assumed that the test pattern TP including the pattern groups PG including a plurality of the individual patterns L corresponding to a length of each of the nozzle rows (33K and 33A) in the sub scanning direction D2 is formed. Here, a plurality of individual patterns LK are formed by liquid ejection from the nozzle row 33K for K, and a plurality of individual patterns LC, LM, and LY are formed by liquid ejection from the color nozzle row 33A. The plurality of individual patterns LC are formed by liquid ejection from the nozzle group 33C for C, the plurality of individual patterns LM are formed by liquid ejection from the nozzle group 33M for M, and the plurality of individual patterns LY are formed by liquid ejection from the nozzle group 33Y for Y. FIG. 9 illustrates that the nozzle row 33K for K includes 20 nozzles 34K for K, the nozzle group 33C for C includes six color nozzles 34A, the nozzle group 33M for M includes six color nozzles 34A, and the nozzle group 33Y for Y includes six color nozzles 34A for easy understanding. Illustration of the unused nozzle 34N is omitted. Further, FIG. 9 illustrates the respective pattern groups PG in which the plurality of the individual patterns L are divided into two in the main scanning direction D1 and arranged in a staircase pattern. Of course, the number of nozzles 34 included in each of the nozzle rows (33K and 33A) may be larger than the number illustrated in FIG. 9.

When viscosity of the liquid 36 in the nozzle 34 increases, air bubbles are mixed into the nozzle 34, dust or paper powder adheres to the nozzle 34, or the like, the droplet 37 is not ejected from the nozzle 34 or the droplet 37 ejected from the nozzle 34 does not land at a normal position on the medium ME0 in some cases. When the defective nozzle LN from which the droplet 37 is not normally ejected occurs, the individual pattern L is not formed at an individual pattern position LP of the defective nozzle LN. When the reading unit 60 reads the test pattern TP and the control unit U1 specifies which individual pattern L is not formed in the sub scanning direction D2, the control unit U1 can detect a position of the defective nozzle LN corresponding to the individual pattern position LP. However, as an upper end position 901 illustrated in FIG. 9, when the defective nozzles LN are present at the same position in both the nozzle rows (33K and 33A), the control unit U1 cannot recognize the individual pattern positions LP of the defective nozzles LN in some cases and thus cannot detect the positions of the defective nozzles LN in some cases. In particular, when the defective nozzles LN are present at end portions of both the nozzle rows (33K and 33A), the control unit U1 cannot specify first individual patterns L in the sub scanning direction D2 and cannot detect the positions of the defective nozzles LN. In addition, since there is a location where the individual pattern L is not formed by the unused nozzle 34N in the pattern group PG formed by liquid ejection from the color nozzle row 33A, when the individual pattern position LP of the defective nozzle LN is adjacent to the individual pattern position of the unused nozzle 34N as an adjacent position 902 illustrated in FIG. 9, the control unit U1 cannot recognize the individual pattern position LP of the defective nozzle LN in some cases. As a result, the control unit U1 cannot detect the position of the defective nozzle LN in some cases. Further, also when the nozzle 34K for K corresponding to the unused nozzle 34N of the color nozzle row 33A in the nozzle row 33K for K is the defective nozzle LN, the individual pattern position LP of the defective nozzle LN cannot be recognized in some cases, and thus the position of the defective nozzle LN cannot be detected in some cases.

In this specific example, as illustrated in FIG. 4, by dividing the pattern groups PG by liquid ejection from the nozzle rows (33K and 33A) into a plurality of groups and arranging the groups in the main scanning direction D1, reliability of detecting the position corresponding to the defective nozzle LN is improved. Accordingly, a situation in which the defective nozzle LN cannot be detected is suppressed.

First, a classification example of the nozzle groups will be described with reference to FIG. 3. For ease of understanding, the nozzle row 33 illustrated in FIG. 3 is matched with the nozzle row 33 illustrated in FIG. 9. That is, the nozzle row 33K for K includes 20 nozzles 34K for K, the nozzle group 33C for C includes six color nozzles 34A, the nozzle group 33M for M includes six color nozzles 34A, and the nozzle group 33Y for Y includes six color nozzles 34A.

The plurality of nozzles 34K for K include the first sequential nozzle group NG1 that is sequential in the sub scanning direction D2, the second sequential nozzle group NG2 that is sequential in the sub scanning direction D2, the third sequential nozzle group NG3 that is sequential in the sub scanning direction D2, and the fourth sequential nozzle group NG4 that is sequential in the sub scanning direction D2. In FIG. 3, the first sequential nozzle group NG1, the second sequential nozzle group NG2, the third sequential nozzle group NG3, and the fourth sequential nozzle group NG4 are arranged in this order in the sub scanning direction D2. In the example illustrated in FIG. 3, the number of nozzles 34K for K in each of the sequential nozzle groups (NG1 to NG4) is five.

The plurality of color nozzles 34A include the nozzle group 33C for C in which a plurality of the nozzles 34 capable of ejecting the liquid 36 of C onto the medium ME0 are sequentially arranged, the nozzle group 33M for M in which a plurality of the nozzles 34 capable of ejecting the liquid 36 of M onto the medium ME0 are sequentially arranged, and the nozzle group 33Y for Y in which a plurality of the nozzles 34 capable of ejecting the liquid 36 of Y onto the medium ME0 are sequentially arranged. In the example illustrated in FIG. 3, the number of each of the nozzle groups (33C, 33M, and 33Y) is six. In the sub scanning direction D2, there is one unused nozzle 34N between the nozzle group 33C for C and the nozzle group 33M for M, and there is one unused nozzle 34N between the nozzle group 33M for M and the nozzle group 33Y for Y. In FIG. 3, the nozzle group 33C for C, the unused nozzle 34N, the nozzle group 33M for M, the unused nozzle 34N, and the nozzle group 33Y for Y are arranged in this order in the sub scanning direction D2.

The nozzle group 33C for C is an example of the first sequential color nozzle group NG11, and is also an example of the fifth sequential nozzle group NG5 that is sequential in the sub scanning direction D2. The nozzle group 33M for M is an example of the second sequential color nozzle group NG12, and is also an example of the sixth sequential nozzle group NG6 that is sequential in the sub scanning direction D2. The nozzle group 33Y for Y is an example of the third sequential color nozzle group NG13, and is also an example of a seventh sequential nozzle group NG7 that is sequential in the sub scanning direction D2.

Next, a configuration example of the test pattern TP will be described with reference to FIG. 4. For easy understanding, FIG. 4 illustrates the respective pattern groups PG in which a plurality of the individual patterns L are divided into two in the main scanning direction D1 and arranged in a staircase pattern. The test pattern TP includes the pattern groups (PG1 to PG4) derived from liquid ejection from the nozzle row 33K for K and the pattern groups (PG11 to PG13) derived from liquid ejection from the color nozzle row 33A.

The first pattern group PG1 is derived from liquid ejection from the first sequential nozzle group NG1, and includes a plurality of the individual patterns LK. The second pattern group PG2 is derived from liquid ejection from the second sequential nozzle group NG2, and includes a plurality of the individual patterns LK. The third pattern group PG3 is derived from liquid ejection from the third sequential nozzle group NG3, and includes a plurality of the individual patterns LK. The fourth pattern group PG4 is derived from liquid ejection from the fourth sequential nozzle group NG4, and includes a plurality of the individual patterns LK. The first color pattern group PG11 is derived from liquid ejection from the first sequential color nozzle group NG11, and includes a plurality of the individual patterns LC. The first color pattern group PG11 can also be said to be the fifth pattern group PG5 derived from liquid ejection from the fifth sequential nozzle group NG5. The second color pattern group PG12 is derived from liquid ejection from the second sequential color nozzle group NG12, and includes a plurality of the individual patterns LM. The second color pattern group PG12 can also be said to be the sixth pattern group PG6 derived from liquid ejection from the sixth sequential nozzle group NG6. The third color pattern group PG13 is derived from liquid ejection from the third sequential color nozzle group NG13, and includes a plurality of the individual patterns LY. The third color pattern group PG13 can also be said to be a seventh pattern group PG7 derived from liquid ejection from the seventh sequential nozzle group NG7.

As illustrated in FIG. 4, a position in the sub scanning direction D2 of each individual pattern L included in each pattern group PG coincides with a position in the sub scanning direction D2 of any of the individual patterns L included in the other pattern groups PG. For example, it can be said that locations in the sub scanning direction D2 of the individual patterns L1, L2, L3, L4, L5, L6, and L7 at seven locations illustrated in FIG. 4 coincide with each other. When attention is paid to each individual pattern LK of the first pattern group PG1, it can be seen that the individual pattern L having the same position in the sub scanning direction D2 is present in the other pattern groups (PG2 to PG6). When attention is paid to each individual pattern LC of the fifth pattern group PG5, it can be seen that at least the individual pattern LM having the same position in the sub scanning direction D2 is present in the sixth pattern group PG6, and the individual pattern LY having the same position in the sub scanning direction D2 is present in the seventh pattern group PG7. Since any of the other individual patterns L is present at a position in the sub scanning direction D2 of each individual pattern L, a situation in which the defective nozzle LN cannot be detected is suppressed.

In the test pattern TP illustrated in FIG. 4, the number of pattern groups PG for K derived from liquid ejection from the nozzle row 33K of K is four. When the number of pattern groups PG for K derived from liquid ejection from the nozzle row 33K of K is three or less, a length of the pattern group PG in the sub scanning direction D2 is longer than those of the color pattern groups (PG11 to PG13) derived from liquid ejection from the color nozzle row 33A. In this case, in the pattern group PG of K, the individual pattern LK is generated whose position in the sub scanning direction D2 does not coincide with positions of the individual patterns LC, LM, and LY of the color pattern groups (PG11 to PG13). When the number of pattern groups PG of K derived from the liquid ejection from the nozzle row 33K for K is four, the length of the pattern group PG in the sub scanning direction D2 can be made shorter than those of the color pattern groups (PG11 to PG13). Thus, the position of the individual pattern LK can be matched with the positions of the individual patterns LC, LM, and LY in the sub scanning direction D2. However, when the number of pattern groups PG of derived from liquid ejection from the nozzle row 33K for K is five or more, the number of times of the main scanning SC1 and the sub scanning SC2 increases, and thus formation of the test pattern TP is delayed. Therefore, from the viewpoint of a formation speed of the test pattern TP and detection accuracy of the defective nozzle LN, it is optimum that the number of pattern groups PG derived from liquid ejection from one nozzle row is four.

### (3) Specific Example of Test Pattern Forming Method

FIGS. 5 and 6 schematically illustrate a specific example of the test pattern forming method for printing the test pattern TP illustrated in FIG. 4. The test pattern forming method includes the first pattern group forming step ST1, the sub scanning step ST3, and the second pattern group forming step ST2.

The controller 10 performs control to form the test pattern TP on the medium ME0 according to test pattern data for forming the test pattern TP. Therefore, it can be said that the printer 2 performs the test pattern forming method under the control of the controller 10.

First, the control unit U1 performs control to form the fourth pattern group PG4 on the medium ME0 while performing the main scanning SC1 in a state in which the fourth sequential nozzle group NG4 of the nozzle row 33K for K is within a range of the medium ME0 in the sub scanning direction D2 (a state 501 in FIG. 5). The controller 10 causes the carriage drive unit 51 to perform the main scanning SC1 for moving the recording head 30 along the main scanning direction D1, and causes the droplet 37 of K to be ejected from the fourth sequential nozzle group NG4 in accordance with the test pattern data, to cause the fourth pattern group PG4 of K to be formed at a position set with respect to the medium ME0. The main scanning SC1 may be the main scanning in the forward direction D11 or the main scanning in the backward direction D12. The same applies hereinafter.

Next, the control unit U1 performs the sub scanning SC2 until an upper end of the third sequential color nozzle group NG13, that is, the seventh sequential nozzle group NG7 of the color nozzle row 33A is aligned with an upper end of the fourth pattern group PG4 in the sub scanning direction D2. The controller 10 causes the roller drive unit 55 to perform the sub scanning SC2 for moving the medium ME0 in the feeding direction D3. Therefore, it can be said that the control unit U1 moves the medium ME0 along the sub scanning direction D2. The same applies hereinafter.

Next, the control unit U1 performs control to form the third color pattern group PG13, that is, the seventh pattern group PG7 on the medium ME0 while performing the main scanning SC1 for moving the recording head 30 along the main scanning direction D1 (a state 502 in FIG. 5). The controller 10 causes the carriage drive unit 51 to perform the main scanning SC1, and causes the droplet 37 of Y to be ejected from the seventh sequential nozzle group NG7 in accordance with the test pattern data, to cause the seventh pattern group PG7 of Y to be formed at a position set with respect to the medium ME0. Next, the control unit U1 performs the sub scanning SC2 until an upper end of the third sequential nozzle group NG3 of the nozzle row 33K for K is aligned with an upper end of the pattern groups (PG4 and PG7) in the sub scanning direction D2. The controller 10 causes the roller drive unit 55 to perform the sub scanning SC2 for moving the medium ME0 in the feeding direction D3.

Next, the control unit U1 performs control to form the third pattern group PG3 on the medium ME0 while performing the main scanning SC1 for moving the recording head 30 along the main scanning direction D1 (a state 503 in FIG. 5). The controller 10 causes the carriage drive unit 51 to perform the main scanning SC1, and causes the droplet 37 of K to be ejected from the third sequential nozzle group NG3 in accordance with the test pattern data, to cause the third pattern group PG3 of K to be formed at a position set with respect to the medium ME0. Next, the control unit U1 performs the sub scanning SC2 until an upper end of the second sequential color nozzle group NG12, that is, the sixth sequential nozzle group NG6 of the color nozzle row 33A is aligned with an upper end of the pattern groups (PG3, PG4, and PG7) in the sub scanning direction D2. The controller 10 causes the roller drive unit 55 to perform the sub scanning SC2 for moving the medium ME0 in the feeding direction D3.

Next, the control unit U1 performs control to form the second sequential color nozzle group NG12, that is, the sixth pattern group PG6 on the medium ME0 while performing the main scanning SC1 for moving the recording head 30 along the main scanning direction D1 (a state 504 in FIG. 6). The controller 10 causes the carriage drive unit 51 to perform the main scanning SC1, and causes the droplet 37 of M to be ejected from the sixth sequential nozzle group NG6 in accordance with the test pattern data, to cause the sixth pattern group PG6 of M to be formed at a position set with respect to the medium ME0.

Next, the control unit U1 performs the sub scanning SC2 until an upper end of the second sequential nozzle group NG2 of the nozzle row 33K for K is aligned with an upper end of the pattern groups (PG3, PG4, PG6, and PG7) in the sub scanning direction D2. The controller 10 causes the roller drive unit 55 to perform the sub scanning SC2 for moving the medium ME0 in the feeding direction D3.

Next, the control unit U1 performs control to form the second pattern group PG2 on the medium ME0 while performing the main scanning SC1 for moving the recording head 30 along the main scanning direction D1 (a state 505 in FIG. 6). The controller 10 causes the carriage drive unit 51 to perform the main scanning SC1, and causes the droplet 37 of K to be ejected from the second sequential nozzle group NG2 in accordance with the test pattern data, to cause the second pattern group PG2 of K to be formed at a position set with respect to the medium ME0. In this way, the printer 2 implements the second pattern group forming step ST2.

Next, the control unit U1 performs the sub scanning SC2 until an upper end of the first sequential nozzle group NG1 of the nozzle row 33K for K is aligned with an upper end of the pattern groups (PG2, PG3, PG4, PG6, and PG7) in the sub scanning direction D2. It can be said that the control unit U1 performs the sub scanning SC2 until an upper end of the first sequential color nozzle group NG11, that is, the fifth sequential nozzle group NG5 of the color nozzle row 33A is aligned with the upper end of the pattern groups (PG2, PG3, PG4, PG6, and PG7) in the sub scanning direction D2. The controller 10 causes the roller drive unit 55 to perform the sub scanning SC2 for moving the medium ME0 in the feeding direction D3. In this way, the printer 2 implements the sub scanning step ST3 for performing the sub scanning SC2 such that the first pattern group PG1 and the second pattern group PG2 are arranged in the main scanning direction D1.

Finally, the control unit U1 performs control to form the first pattern group PG1, and the first color pattern group PG11, that is, the fifth pattern group PG5 on the medium ME0 while performing the main scanning SC1 for moving the recording head 30 along the main scanning direction D1 (a state 506 in FIG. 6). The controller 10 causes the carriage drive unit 51 to perform the main scanning SC1, causes the droplet 37 of K to be ejected from the first sequential nozzle group NG1 in accordance with the test pattern data, and causes the droplet 37 of C to be ejected from the fifth sequential nozzle group NG5, to cause the first pattern group PG1 of K and the fifth pattern group PG5 of C to be formed at positions set with respect to the medium ME0. In this way, the printer 2 implements the first pattern group forming step ST1. Thus, the printing of the test pattern TP illustrated in FIG. 4 is completed.

As described above, the control unit U1 performs control to form the test pattern TP in which the pattern groups (PG1 to PG7) are arranged in the main scanning direction D1 by appropriately performing the sub scanning SC2. At this time, the control unit U1 performs control to form the test pattern TP in which the plurality of pattern groups PG are arranged in the main scanning direction D1 so that a position in the sub scanning direction D2 of each individual pattern L included in each pattern group PG coincides with a position in the sub scanning direction D2 of any of the individual patterns L included in the other pattern groups PG. The sub scanning SC2 is performed between formation of the fourth pattern group PG4 and formation of the third pattern group PG3, between formation of the third pattern group PG3 and formation of the second pattern group PG2, and between formation of the second pattern group PG2 and formation of the first pattern group PG1. Further, the sub scanning SC2 is performed between formation of the third color pattern group PG13 and formation of the second color pattern group PG12, and between formation of the second color pattern group PG12 and formation of the first color pattern group PG11.

As illustrated in FIG. 4, since the plurality of pattern groups (PG1 to PG4) formed by the nozzle row 33K for K are arranged in the main scanning direction D1, the number of individual patterns L of K formed at the same position in the sub scanning direction D2 increases. In addition, since the plurality of pattern groups (PG5 to PG7) formed by the color nozzle row 33A are arranged in the main scanning direction D1, the number of individual patterns LC, LM, and LY formed at the same position in the sub scanning direction D2 increases.

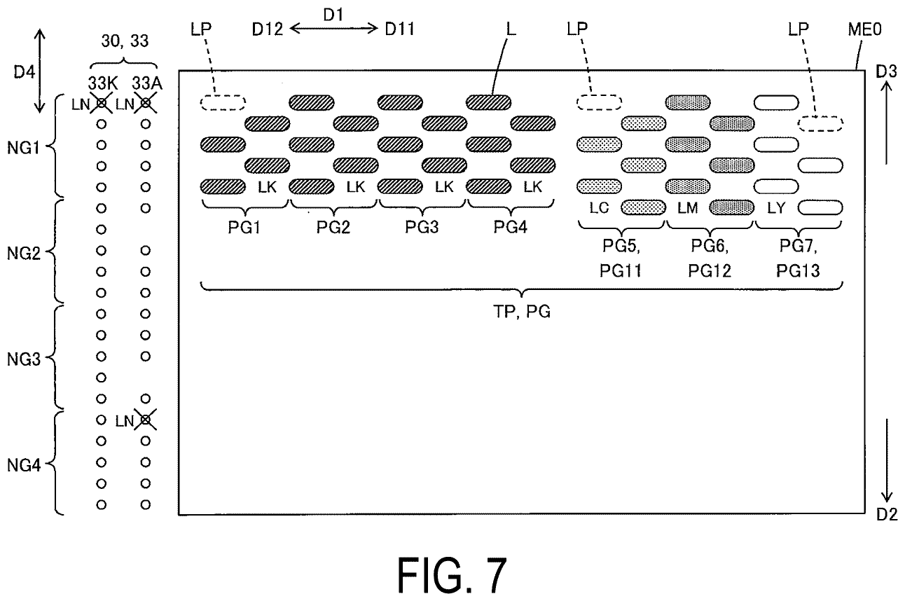

FIG. 7 schematically illustrates the test pattern TP including the individual pattern position LP of the defective nozzle LN. FIG. 7 illustrates that the individual pattern positions LP at which the individual patterns L are not formed occur in the first pattern group PG1 and the fifth pattern group PG5 due to presence of the defective nozzles LN at end portions of both the nozzle rows (33K and 33A). Even in this case, since the individual patterns L are present in the remaining pattern groups (PG2 to PG4, PG6, and PG7), the control unit U1 can specify the first individual patterns L in the sub scanning direction D2. In addition, FIG. 7 illustrates that there is the individual pattern position LP at which the individual pattern LY is not formed in the seventh pattern group PG7 due to presence of the defective nozzle LN in the color nozzle 34A of Y in the color nozzle row 33A. Even in this case, since the individual patterns L are present in the remaining pattern groups (PG1 to PG6), the control unit U1 can specify the individual pattern position LP.

Since the individual pattern position LP is specified, the control unit U1 can detect a position corresponding to the defective nozzle LN. Therefore, in this specific example, it is possible to suppress the situation in which the defective nozzle LN cannot be detected.

Note that when the sub scanning direction D2 and the feeding direction D3 are switched in the example illustrated in FIGS. 4 to 6, the pattern groups of K (PG1 to PG4) are formed in an order of the first pattern group PG1, the second pattern group PG2, the third pattern group PG3, and the fourth pattern group PG4. In this case, the first pattern group forming step ST1 is formed at the time of forming the leading first pattern group PG1, the sub scanning step ST3 is implemented between formation of the first pattern group PG1 and formation of the second pattern group PG2, and the second pattern group forming step ST2 is implemented at the time of forming the second pattern group PG2.

When the defective nozzle LN is detected, the controller 10 determines whether cleaning of the nozzle row 33 is necessary or not based on detection information of the defective nozzle LN, and causes the output unit 25 to display information prompting the cleaning when it is determined that the cleaning is necessary. For this reason, the printer 2 may include a cleaning unit that can implement cleaning of the recording head 30. Upon receiving a cleaning instruction from the input unit 26, the controller 10 causes the cleaning unit to implement cleaning of the recording head 30. In addition, the controller 10 may cause the cleaning unit to automatically implement cleaning of the recording head 30 when it is determined that cleaning is necessary.

### (4) Modification Example

Various modifications of the present disclosure can be considered. For example, the printer 2 may be a monochrome printer having only the nozzle row for K in the recording head. Even in this case, assuming that the nozzle row for K includes a plurality of sequential nozzle groups, a plurality of pattern groups derived from liquid ejection from the plurality of sequential nozzle groups are arranged in the main scanning direction, and thus it is possible to obtain an effect of suppressing a situation in which a defective nozzle cannot be detected.

Part of the above-described processing may be performed by the host device HO1. In this case, a combination of the controller 10, the drive unit 50, and the host device HO1 is an example of the control unit U1, and a combination of the printer 2 and the host device HO1 is an example of the recording device 1.

In the test pattern TP, for example, as long as the first pattern group PG1, the second pattern group PG2, and the first color pattern group PG11 are arranged in the main scanning direction D1, even when the other pattern groups PG are not arranged in the main scanning direction D1, a situation in which the defective nozzles LN generated in the first sequential nozzle group NG1, the second sequential nozzle group NG2, and the first sequential color nozzle group NG11 cannot be detected is suppressed. In addition, as long as the first pattern group PG1, the second pattern group PG2, the fifth pattern group PG5, and the sixth pattern group PG6 are arranged in the main scanning direction D1, even when the other pattern groups PG are not arranged in the main scanning direction D1, it is possible to suppress a situation in which the defective nozzles LN generated in the first sequential nozzle group NG1, the second sequential nozzle group NG2, the fifth sequential nozzle group NG5, and the sixth sequential nozzle group NG6 cannot be detected.

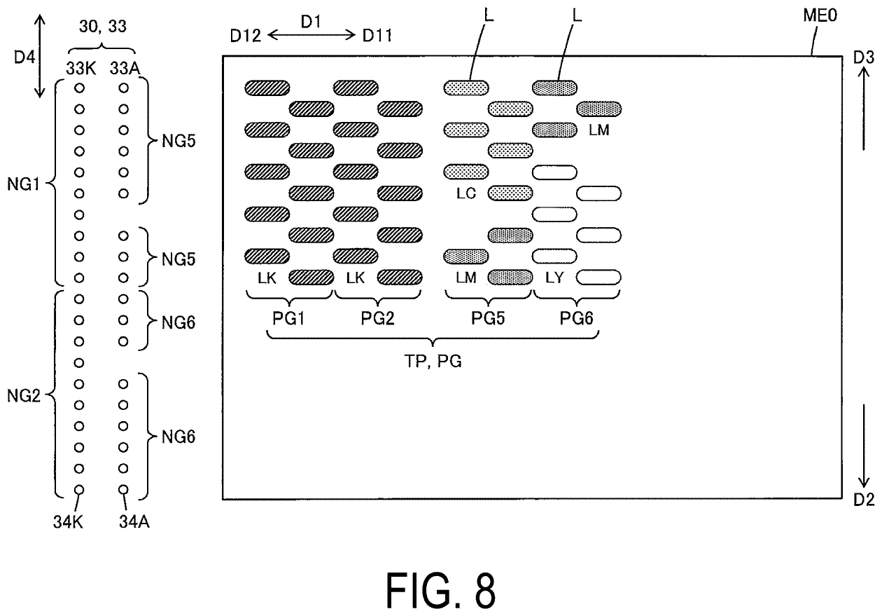

As illustrated in FIG. 8, even when the recording head 30 is a vertical array head, the number of pattern groups PG of K derived from liquid ejection from the nozzle row 33K for K may be two, and the number of pattern groups PG derived from liquid ejection from the color nozzle row 33A may be two. The plurality of nozzles 34K for K illustrated in FIG. 8 include the first sequential nozzle group NG1 that is sequential in the sub scanning direction D2 and the second sequential nozzle group NG2 that is sequential in the sub scanning direction D2. The number of nozzles 34K for K in each of the sequential nozzle groups (NG1 and NG2) is ten. The first pattern group PG1 derived from liquid ejection from the first sequential nozzle group NG1 includes ten individual patterns LK, and the second pattern group PG2 derived from liquid ejection from the second sequential nozzle group NG2 includes ten individual patterns LK. The plurality of color nozzles 34A illustrated in FIG. 8 include the fifth sequential nozzle group NG5 that is sequential in the sub scanning direction D2 and the sixth sequential nozzle group NG6 that is sequential in the sub scanning direction D2. The fifth sequential nozzle group NG5 includes all the color nozzles 34A capable of ejecting the liquid 36 of C onto the medium ME0 and half the color nozzles 34A capable of ejecting the liquid 36 of M onto the medium ME0. The sixth sequential nozzle group NG6 includes the remaining half the color nozzles 34A capable of ejecting the liquid 36 of M onto the medium ME0 and all the color nozzles 34A capable of ejecting the liquid 36 of Y onto the medium ME0. The fifth pattern group PG5 derived from liquid ejection from the fifth sequential nozzle group NG5 includes all the individual patterns LC and half the individual patterns LM. The sixth pattern group PG6 derived from liquid ejection from the sixth sequential nozzle group NG6 includes half the individual patterns LM and all the individual patterns LY.

The test pattern TP illustrated in FIG. 8 can be formed by performing the main scanning SC1 twice and the sub scanning SC2 once, as exemplified below.

(Main scanning SC1 performed first) The control unit U1 causes the second pattern group PG2 and the sixth pattern group PG6 to be formed on the medium ME0 (second pattern group forming step ST2).

(Sub Scanning SC2) The control unit U1 performs the sub scanning SC2 so that the first pattern group PG1, the second pattern group PG2, the fifth pattern group PG5, and the sixth pattern group PG6 are arranged in the main scanning direction D1 (sub scanning step ST3).

(Main scanning SC1 performed second) The control unit U1 causes the first pattern group PG1 and the fifth pattern group PG5 to be formed on the medium ME0 (first pattern group forming step ST1).

Therefore, a formation speed of the test pattern TP can be improved. Of course, when the sub scanning direction D2 and the feeding direction D3 are switched in the example illustrated in FIG. 8, the first pattern group PG1 and the fifth pattern group PG5 are formed, and then the second pattern group PG2 and the sixth pattern group PG6 are formed.

Also in the test pattern TP illustrated in FIG. 8, the number of individual patterns L formed at the same position in the sub scanning direction D2 is increased. Accordingly, even when some of the individual patterns L among the plurality of individual patterns L formed at the same position in the sub scanning direction D2 are not formed due to ejection failures of the nozzles, positions corresponding to defective nozzles LN are detected since the remaining individual patterns L are formed. Therefore, the situation in which the defective nozzle LN cannot be detected is suppressed.

### (5) Conclusion

As described above, according to the present disclosure, by the various aspects, it is possible to provide a configuration or the like capable of suppressing a situation in which a defective nozzle having an ejection failure cannot be detected. Of course, the basic operations and effects described above can be obtained even with an aspect including only components according to the independent claims.

A configuration in which the configurations disclosed in the above-described examples are replaced with one another or the combinations are changed, a configuration in which a known technology and each of the configurations disclosed in the above-described examples are replaced with one another or the combinations are changed, or the like can be implemented. The present disclosure also includes these configurations.

What is claimed is:

1. A recording device, comprising:
a recording head including a first nozzle row in which a plurality of first nozzles configured to eject liquid onto a medium are arranged; and
a control unit configured to control main scanning for moving the recording head along a main scanning direction intersecting with an arrangement direction of the plurality of first nozzles, sub scanning for moving at least one of the medium and the recording head along a sub scanning direction intersecting with the main scanning direction, and ejection of the liquid from the recording head, wherein
the control unit is configured to control formation of a test pattern including a plurality of individual patterns along the main scanning direction by liquid ejection from each of the plurality of first nozzles,
the individual patterns adjacent to each other in the sub scanning direction are located at positions shifted from each other in the main scanning direction,
the plurality of first nozzles include a first sequential nozzle group that is sequential in the sub scanning direction and a second sequential nozzle group that is sequential in the sub scanning direction,
the test pattern includes a first pattern group derived from liquid ejection from the first sequential nozzle group and a second pattern group derived from liquid ejection from the second sequential nozzle group, and
the control unit performs control to form the test pattern in which at least the first pattern group and the second pattern group are arranged in the main scanning direction by performing the sub scanning between formation of the first pattern group and formation of the second pattern group.

2. The recording device according to claim 1, wherein
the plurality of first nozzles further include a third sequential nozzle group that is sequential in the sub scanning direction and a fourth sequential nozzle group that is sequential in the sub scanning direction,
the test pattern includes the first pattern group, the second pattern group, a third pattern group derived from liquid ejection from the plurality of third sequential nozzles, and a fourth pattern group derived from liquid ejection from the plurality of fourth sequential nozzles,
in the test pattern, the number of pattern groups derived from liquid ejection from the first nozzle row is four, and
the control unit performs control to form the test pattern in which at least the first pattern group, the second pattern group, the third pattern group, and the fourth pattern group are arranged in the main scanning direction by performing the sub scanning between formation of the second pattern group and formation of the third pattern group and performing the sub scanning between formation of the third pattern group and formation of the fourth pattern group.

3. The recording device according to claim 1, wherein
the recording head includes a second nozzle row along the first nozzle row, the second nozzle row having a plurality of second nozzles being arranged therein,
the plurality of second nozzles include a first sequential color nozzle group in which a plurality of first color nozzles configured to eject a first color liquid onto the medium are sequentially arranged, a second sequential color nozzle group in which a plurality of second color nozzles configured to eject a second color liquid onto the medium are sequentially arranged, and a third sequential color nozzle group in which a plurality of third color nozzles configured to eject a third color liquid onto the medium are sequentially arranged,
the test pattern includes a first color pattern group derived from liquid ejection from the first sequential color nozzle group, a second color pattern group derived from liquid ejection from the second sequential color nozzle group, and a third color pattern group derived from liquid ejection from the third sequential color nozzle group, and
the control unit performs control to form the test pattern in which at least the first pattern group, the second pattern group, and the first color pattern group are arranged in the main scanning direction.

4. The recording device according to claim 1, wherein
the recording head includes a second nozzle row along the first nozzle row, the second nozzle row having a plurality of second nozzles being arranged therein,
the plurality of second nozzles include a fifth sequential nozzle group that is sequential in the sub scanning direction and a sixth sequential nozzle group that is sequential in the sub scanning direction,
the test pattern includes a fifth pattern group derived from liquid ejection from the fifth sequential nozzle group and a sixth pattern group derived from liquid ejection from the sixth sequential nozzle group, and
the control unit performs control to form the test pattern in which at least the first pattern group, the second pattern group, the fifth pattern group, and the sixth pattern group are arranged in the main scanning direction by performing the sub scanning between formation of the fifth pattern group and formation of the sixth pattern group.

5. The recording device according to claim 1, wherein
the test pattern includes a plurality of pattern groups including the first pattern group and the second pattern group, and
the control unit performs control to form the test pattern in which the plurality of pattern groups are arranged in the main scanning direction so that a position in the sub scanning direction of each of the individual patterns included in each of the pattern groups coincides with a position in the sub scanning direction of any of the individual patterns included in the other pattern groups.

6. A test pattern forming method for forming a test pattern by performing main scanning for moving a recording head including a first nozzle row in which a plurality of first nozzles configured to eject liquid onto a medium are arranged along a main scanning direction intersecting with an arrangement direction of the plurality of first nozzles, and sub scanning for moving at least one of the medium and the recording head along a sub scanning direction intersecting with the main scanning direction, wherein
the test pattern includes a plurality of individual patterns along the main scanning direction by liquid ejection from each of the plurality of first nozzles,
the individual patterns adjacent to each other in the sub scanning direction are located at positions shifted from each other in the main scanning direction,
the plurality of first nozzles include a first sequential nozzle group that is sequential in the sub scanning direction and a second sequential nozzle group that is sequential in the sub scanning direction,
the test pattern forming method includes
a first pattern group forming step for forming a first pattern group on the medium by ejecting the liquid from the first sequential nozzle group,
a second pattern group forming step for forming a second pattern group on the medium by ejecting the liquid from the second sequential nozzle group, and
a sub scanning step for performing the sub scanning such that the first pattern group and the second pattern group are arranged in the main scanning direction.
